(19) United States
(12) Patent Application Publication
(10) Pub. No.: US 2003/0172317 A1
(43) Pub. Date: Sep. 11, 2003

(54) Information processor and maintenance service system for the same

(76) Inventors: Motoyasu Tsunoda, Kawasaki (JP); Atsushi Saito, Odawara (JP); Takashi Tsunehiro, Kawasaki (JP)

Correspondence Address: Robert C Colwell, Townsend and Townsend and Crew, Two Embarcadero Center 8th Floor, San Francisco, CA, 94111-3834, US

(21) Appl. No.: 10/204,203

(22) PCT Filed: Feb. 14, 2001
(86) PCT No.: PCT/JP01/01025

(30) Foreign Application Priority Data
Feb. 15, 2000 (JP) 2000-41367

(51) Int. Cl. G06F 12/14; G06F 12/16

(52) U.S. Cl. 714/7; 711/115; 711/164

(57) ABSTRACT

An information processing device, wherein a set-top box (102) that houses a removable hard disk device (101) is connected to a monitor (103), and the set-top box (102) comprises a host unit (201) and a hard disk device (101). The host unit (201) comprises an HDD interface controller (202), a user interface controller (209), and the like.

The HDD interface controller (202) comprises a removal control unit (213), a locking mechanism (212), and the like. The removal control unit (213) controls removal of the hard disk device (101) with consideration for copyright protection. The locking mechanism (212) anchors the hard disk device (101) such that the hard disk device (101) cannot easily be removed from the set-top box (102), and releases the lock solely on the basis of the instructions of the removal control unit (213).

### TECHNICAL FIELD

The present invention relates to a technique for protecting a copyright of content in an information processing device comprising a built-in storage device.

### BACKGROUND ART

With the spread of satellite broadcasts and cable television broadcasts, proposals have been made concerning information processing devices in which hard disk devices are mounted in video recorders and other broadcasting receivers, and the transmitted movies, music, and other types of content are recorded in the hard disk device. Since the data handled in such systems are digitized, protecting the copyright of the persons who have created this content becomes an important task. For this reason, the content is recorded in coded form, or the hard disk device is prevented from being easily removed from a broadcasting receiver. In cases in which easy removal of the hard disk device is permitted for security reasons, techniques are implemented in which read/write-disabling means and removal detection means are provided to the hard disk device, and access to the disk device is denied by the disabling means when the hard disk device is removed, as described, for example, in Japanese Patent Application Laidopen 8-138307. In these cases, access to the disk device is permitted if a preset PIN is matched during reinstallation.

Hard disk devices comprise motors and other mechanical parts, and are thus in danger of failure. In addition, it is imperative that a hard disk device mounted in a broadcasting receiver be replaceable because the disk becomes obsolete in a few years due to rapid technological progress. If the hard disk device cannot be easily removed from a broadcasting receiver, the hard disk device must be replaced by a maintenance service person visiting each household and replacing the disk device, or by the users bringing or mailing their broadcasting receivers to a retail outlet or service center. Such replacement requires considerable time and cost.

When easy removal of a disk device is enabled by a conventional technique, the PIN is set by the users themselves, making it impossible to prevent the users from making unauthorized copies of the content in violation of copyright law. In the converse case of content that does not require copyright protection, a user unfamiliar with the PIN will not be able to use the disk device, and will thus be inconvenienced. In addition, a failed disk device can be easily removed, but the purchased content is lost.

### DISCLOSURE OF THE INVENTION

An object of the present invention relates to an information processing device having a removable hard disk device incorporated therein, and is to provide a technique for controlling the removal of and the restricted access to the disk device on which content is recorded while protecting the copyright.

A second object of the present invention is to provide an information processing device for reducing user inconvenience when a removable storage device has failed, and to provide a maintenance service system thereof.

Another object is to provide a technique for minimizing damage to the users when the disk device has a breakdown.

In order to attain the objects of the present invention, an information processing device having a removable recording/playback device incorporated therein is provided with command issuing means for notifying the recording/playback device of host ID information that is specific to the information processing device; locking means for disabling the removal of the recording/playback device; command issuing means for enquiring about the authorization to remove the recording/playback device; and removal control means for enabling the removal and instructing the locking means to release the lock on the basis of the command response.

Further, the recording/playback device comprises means for retaining host ID information; means for retaining removal authorization flag information indicating whether there is content for which removal of the recording/playback device is disabled for copyright protection; means for retaining removal-state flag information designed to prevent the reuse of a recording/playback device forcibly removed by an unauthorized person; and content recording management means for performing detailed control over the recorded content. Furthermore, the content recording management means are provided with means for retaining content ID information that is inherent ID information contained in each type of content; host ID information issued by a host which has instructed a content write routine; content effective flag information indicating whether the currently connected host is able to access the content; and removable control information indicating whether a recording/playback device having recorded content is enabled to remove.

Further, an on-line maintenance service system for an information processing device having a removable recording/playback device incorporated therein is provided with means for having the recording/playback device retain ID information specific to the recording/playback device; means for forecasting and diagnosing a failure of the recording/playback device; means which, when it is judged that replacement is required due to a failure, authorize the removal of the recording/playback device and certify that the replacement has been performed properly by verifying the the device IDs of the recording/playback device before and after the replacement; and means for redelivering the purchased content for the replacement recording/playback device upon receipt of the certification. The system is further provided with means which, when it is judged that replacement is required due to a possible failure, authorize the removal in a similar manner to the above after data in the recording/playback device have been back up, and certify that the replacement has been performed properly by verifying the device IDs of the recording/playback device before and after the replacement. The system is further provided with means which, when the user wants to upgrade the recording/playback device, move the content for which the removal is disabled, authorize the removal after a removal-enabling state has been established, and certify that the replacement has been performed properly by verifying the device IDs of the new recording/playback device and the old recording/playback device.

### BRIEF DESCRIPTION OF THE DRAWINGS

FIG. 1 is a diagram depicting an information processing device according to the present invention;

FIG. 2 is a system block diagram of the information processing device according to the present invention;

FIG. 3 is a diagram depicting an example of a content recording management table according to the present invention;

FIG. 4 is a flowchart of an initial setup of a hard disk device according to the present invention;

FIG. 5 is a flowchart of a content write routine in a host unit according to the present invention;

FIG. 6 is a diagram depicting an example of a format for transferred data according to the present invention;

FIG. 7 is a flowchart of a content write routine in a hard disk device according to the present invention;

FIG. 8 is a flowchart of the removal routine in a host unit according to the present invention;

FIG. 9 is a flowchart of the removal routine in a hard disk device according to the present invention;

FIG. 10 is a flowchart of a failure-diagnosing routine according to the present invention;

FIG. 11 is a block diagram of an online maintenance service system according to the present invention;

FIG. 12 is an example of user registration information and disk registration information according to the present invention;

FIG. 13 is an example of an online maintenance service model according to the present invention: and FIG. 14 is a flowchart of an online maintenance service routine according to the present invention.

### BEST MODE FOR CARRYING OUT THE INVENTION

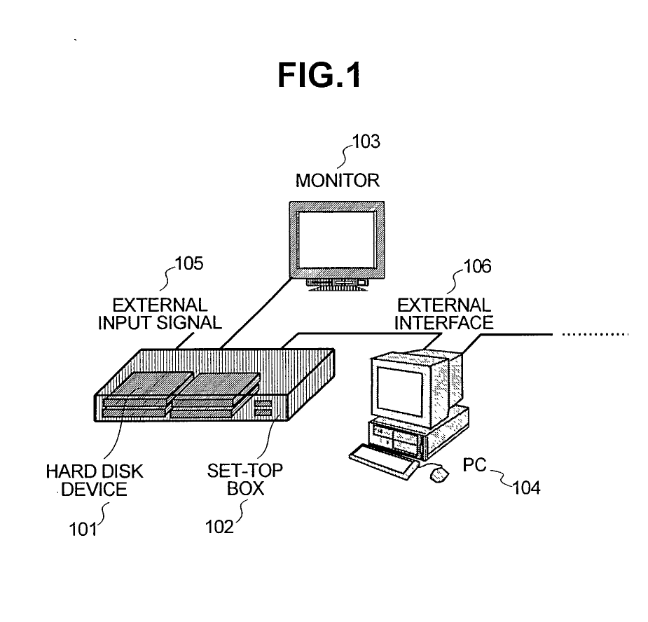

FIG. 1 depicts the first embodiment of the present invention, comprising an information processing device in which a set-top box 102 which houses a removable hard disk device (storage device) 101 is connected to a monitor 103. The hard disk device 101 can easily be removed in the present working example while respecting copyright protection when externally input information (external input signal 105) such as cable broadcasts, satellite broadcasts, or the like are recorded in the hard disk device 101. The set-top box 102 may be connected with other devices such as a PC (personal computer) 164 or the like via an external interface 106.

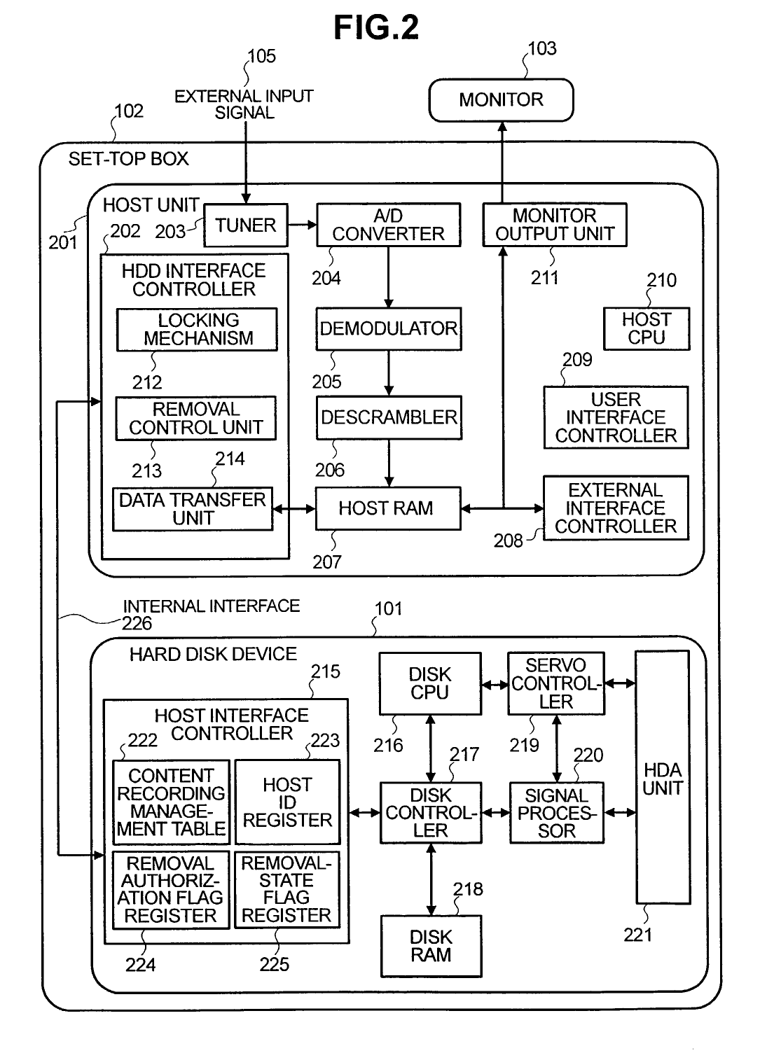

FIG. 2 is a block diagram of the set-top box 102 and hard disk device 101 depicted in FIG. 1. The set-top box 102 comprises a host unit 201 and the hard disk device 101. The host unit 201 comprises a tuner 203, an A/D converter 204, a demodulator 205, a descrambler 206, host RAM 207, a monitor output unit 211, a HDD interface controller 202, an external interface controller 208, a user interface controller 209, and a host CPU 210. The external input signal 105 consisting of cable broadcasts, satellite broadcasts, or the like is detected in the tuner 203 and converted into digital information in the A/D converter 204. The converted input signal 105 is sent to the host RAM 207 via the demodulator 205 and the descrambler 206.

The input signal 105 is transferred to a monitor 103 via the monitor output unit 211 when displayed as information; to the hard disk device 101 via the HDD interface controller 202 when recorded in the hard disk device 101; and to an external device via the external interface controller 208 when transferred to an external device. The user specifies recording, regeneration, transfer, and similar routines for information to the set-top box 102 via the user interface controller 209, and the host CPU 210 receives the instructions and performs control for a series of blocks.

The HDD interface controller 202 comprises a data transfer unit 214, a removal control unit 213, and a locking mechanism 212. The data transfer unit 214 controls data transfer between the host RAM 207 and the hard disk device 101. The removal control unit 213 controls the removal of the hard disk device 101 while respecting copyright protection. The locking mechanism 212 anchors the hard disk device 101 such that the hard disk device 101 cannot easily be removed from the set-top box 102, and releases the lock solely on the basis of the instructions of the removal control unit 213. For the locking and releasing method of the hard disk device 101, a cassette tape loading mechanism of an already known video cassette tape recorder may be adopted, or an electrically-keyed drawer may be placed in the set-top box 102, the hard disk device 101 stored within the drawer, and the lock opened electrically on the basis of the instructions of the removal control unit 213.

The hard disk device 101 comprises a disk CPU 216, a host interface controller 215, a disk controller 217, disk RAM 218, a signal processor 220, a servo controller 219, and an HDA unit 221. The disk CPU 216 controls data processing in the hard disk device 101 as a whole.

The disk controller 217 controls data transfer between the host interface controller 215 and the disk RAM 218, and between the signal processor 220 and the disk RAM 218. The signal processor 220 performs data encoding/decoding processing and A/D conversion. The HDA unit 221 comprises a recording medium for storing data, a spindle motor for stabilizing the recording medium, a read/write head, an actuator for supporting the head, a voice coil motor for moving the actuator, and the like. The servo controller 219 controls the spindle motor and voice coil motor. The host interface controller 215 comprises a removal authorization flag register 224, a removal-state flag register 225, a content recording management table 222, and a host ID register 223; and is connected with the host unit 201 via an internal interface 226. Specific examples of internal interfaces include ATA, IEEE1394, SSA, Fiber Channel, and the like; and any interface standard capable of transmitting between the host unit 201 and the hard disk device 101 may be applied.

The removal authorization flag register 224 indicates whether or not the content stored in the hard disk device 101 contains content that disables removal of the hard disk device 101 in order to preserve copyrights: The removal-state flag register 225 consists of flag information for preventing the reuse of a hard disk device 101 that has been forcibly removed by an unauthorized person. This should be controlled such that an enabled state is set only if the hard disk device 101 is removed according to the proper steps, the flag state is checked upon remounting of the hard disk device 101, and the host unit 201 access is authorized. Information for the detailed control of recorded content is stored in the content recording management table 222. The host ID relayed from the host unit 201 is stored in the host ID register 223. Though not shown in the diagrams, a plurality of hard disk devices 101 may be connected to the internal interface 226.

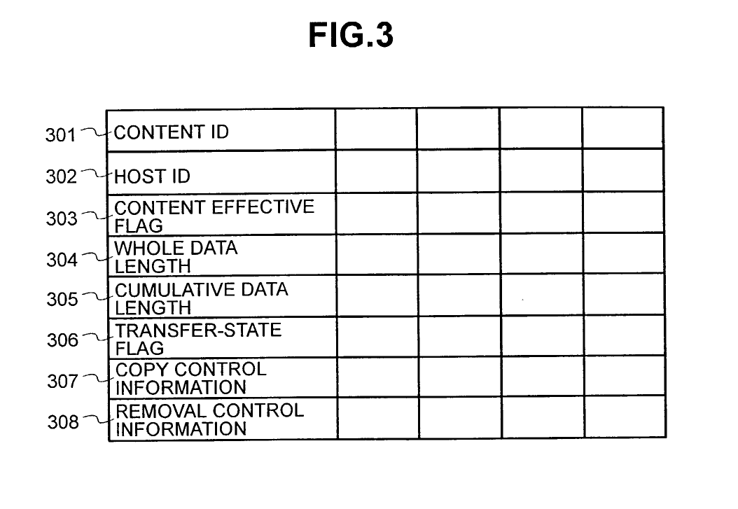

FIG. 3 depicts an example of the content recording management table 222. Inherent ID information contained in each item of content is recorded in the content ID 301. Inherent ID information held by the host unit 201, which specifies a content write routine to the hard disk device 101, is stored in the host ID 302. A content effective flag 303 is a flag for indicating whether the currently connected host unit 201 is capable of content access. Data indicating the data length of the content as a whole are stored in the whole data length 304. Information indicating the data length already recorded during content recording is stored in the cumulative data length 305.

A transfer-state flag 306 indicates whether content is being recorded, whether errors have been generated during recording, and the like. Information as to whether content can be copied is stored in the copy control information 307. For example, information such as “freely copyable,” “once-only copyable,” “copied,” “uncopyable,” and the like is stored. Information indicating authorization of the removal of the hard disk device 101 in which content is recorded is stored in the removal control information 308. A content holder can thus obtain a higher level of copyright protection of content by setting the copy control to “uncopyable,” and the removal control to “unremovable.”

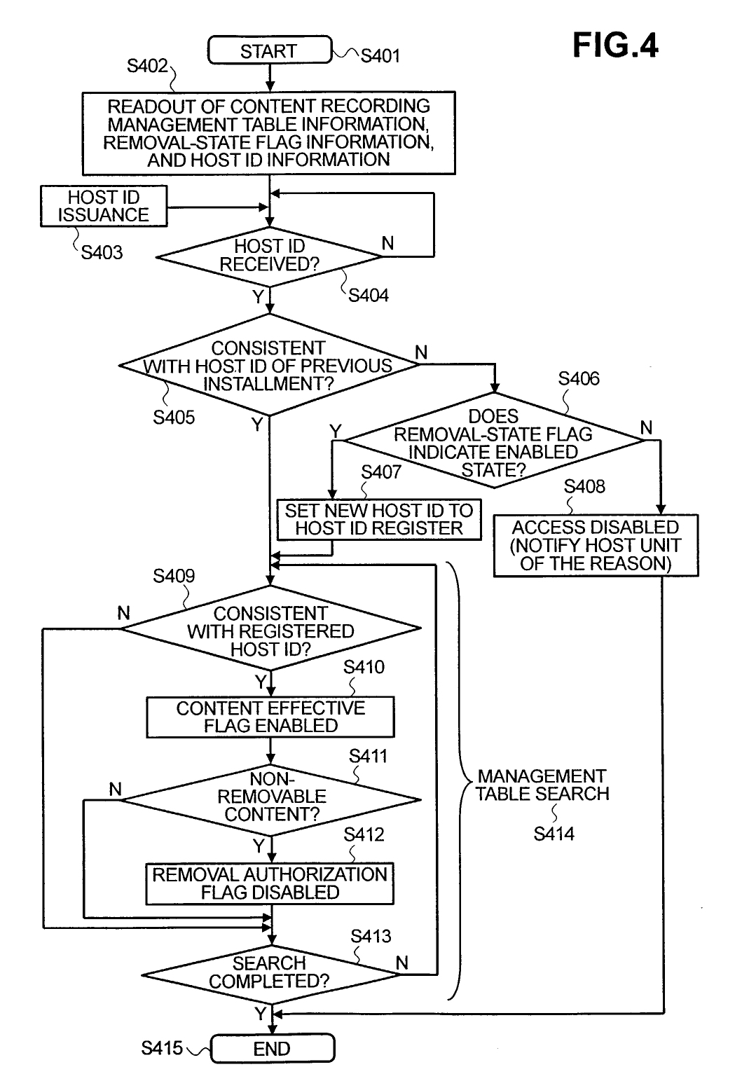

FIG. 4 is an operational flowchart of an initial setup of the hard disk device 101. When initial setup of power-on, system reset, or the like is required, the hard disk device 101 reads the content recording management table information stored in advance in the recording medium, the flag information indicating the removal-state, and the host ID information from the recording medium, and installs each to the management table, removal-state flag register, and host ID register (S402). In this case, the host ID information indicates the host ID 302 issued by the host unit 201, which previously accessed the hard disk device 101. The host ID 302 is issued to obtain access privileges from the host unit 201 for content stored in the hard disk device 101 (S403).

The hard disk device 101 receives the host ID 302 (S404) and executes (S405), comparing the host ID stored in the host ID register 223 with the host ID issued. If the host ID is inconsistent, the hard disk device 101 further determines whether or not the removal-state flag register 225 value indicates an enabled state (S406). If a disabled state is indicated, access from the host unit 201 is disabled because the possibility exists of the hard disk device 101 having been improperly removed, and the reason thereof is relayed to the host unit (S408). If the removal-state flag register 225 value indicates an enabled state, the hard disk device 101 is determined to have been removed according to the regular procedure, and the newly issued host ID from the host unit 201 is stored in the host ID register 223 (S407).

After determination of the presence or absence of improper removal, the hard disk device 101 determines the consistency of the host ID issued by the host unit 201 with each entry on the management table 222 (S409). If the host ID is consistent, the hard disk device 101 sets the content effective flag 303 of the entry to an enabled state (S410). The hard disk device 101 determines whether non-removable content exists by using the removal control information 308 from the management table 222 (S411). If non-removable content exists, the hard disk device 101 sets the removal authorization flag register 224 to a disabled state (S412).

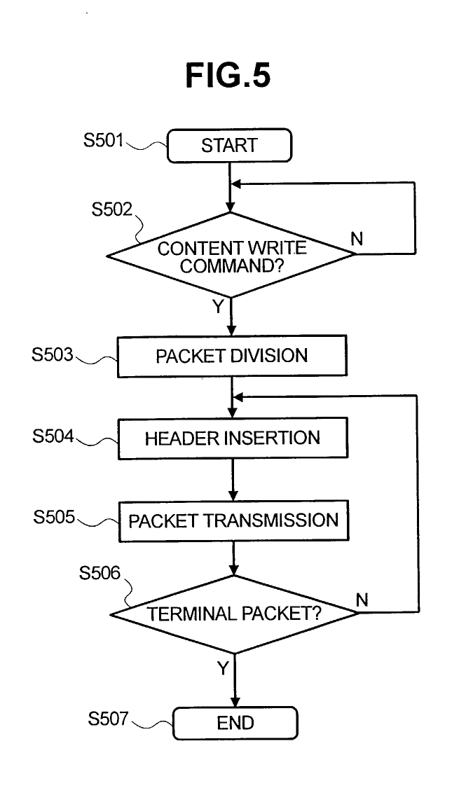

FIG. 5 is a flowchart of a content write routine of the HDD interface controller 202 in the host unit 201. The host CPU 210 sends a content write command to the HDD interface controller 202 when externally input content is stored in the hard disk device 101 (S502). When a write command is received, the data transfer unit 214 transfers the content data buffered in the host RAM 207 to the hard disk device 101 based on the specification of the internal interface 226.

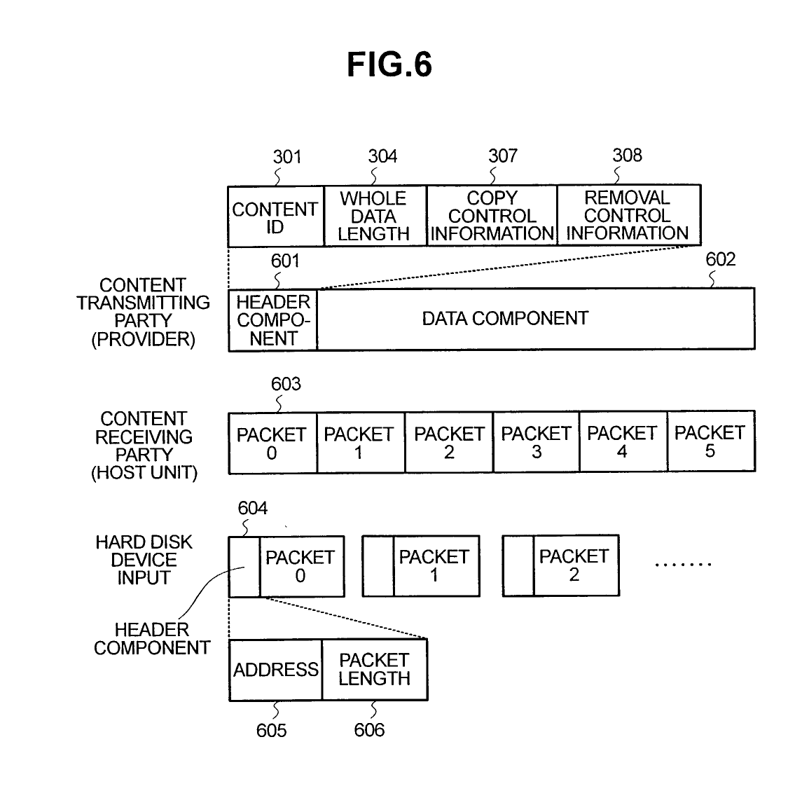

FIG. 6 is an example of a format for the transferred data. When transmitting, a provider or similar content transmitting party transmits the content with a header component 601 added to the beginning of the data portion contained in the content. The content ID 301, whole data length 304, copy control information 307, and removal-control information 308 are contained in the header component 601. The content receiver (host unit 201) divides the transmitted data into packets 603 so that all of the transmitted data can be efficiently recorded in the hard disk device 101 (S503). The host unit 201 generates and inserts a header 604 for each packet 603 based on the specification of the internal interface 226 (S504), and transfers these to the hard disk device 101 (S505).

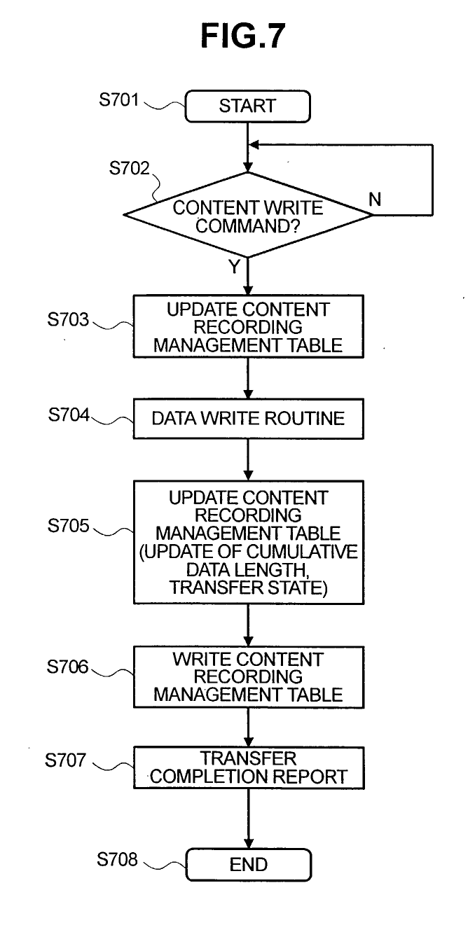

FIG. 7 is a flowchart of a write routine for content in the hard disk device 101. The hard disk device 101 updates the content recording management table 222 (S703) when a content write command is received from the host unit 201 (S702). The content ID 301, whole data length 304, copy control information 307, and removal control information 308 are set according to information obtained from the header component 601 of the content. The host ID 302 adopts the host ID register 223 value, and the content effective flag 303 is set to an enabled state. The packet data are written to the recording medium (S704), the hard disk device 101 adds the recorded data length to the cumulative data length 305, and the packet transfer results are set to the transfer-state flag 306 (S705). For example, it is indicated whether errors have been generated during packet transfer, whether recording of content is in progress or completed, and the like. The hard disk device 101 also updates the removal authorization flag register 224 value on the basis of the removal control information 308.

The hard disk device 101 stores the updated content recording management table 222 in the recording medium (S706) and relays a transfer completion report to the host unit 201 (S707). The format and content recording commands during content recording between the host unit 201 and the hard disk device 101,1 or between the content transmitting party and the hard disk device 101, should preferably be defined in advance, as a method by which the hard disk device 101 ascertains header lengths and contents of the content header components 601. The host unit 201 reads the content recording management table 222 to ascertain content accessible by the host unit 201 when content is read from the hard disk device 101. At this time, the hard disk device 101 transfers to the host unit 201 as many entries as are consistent with the host ID 302 of the host unit 201. Readout of the content is thus possible only for the host unit 201 that wrote the content.

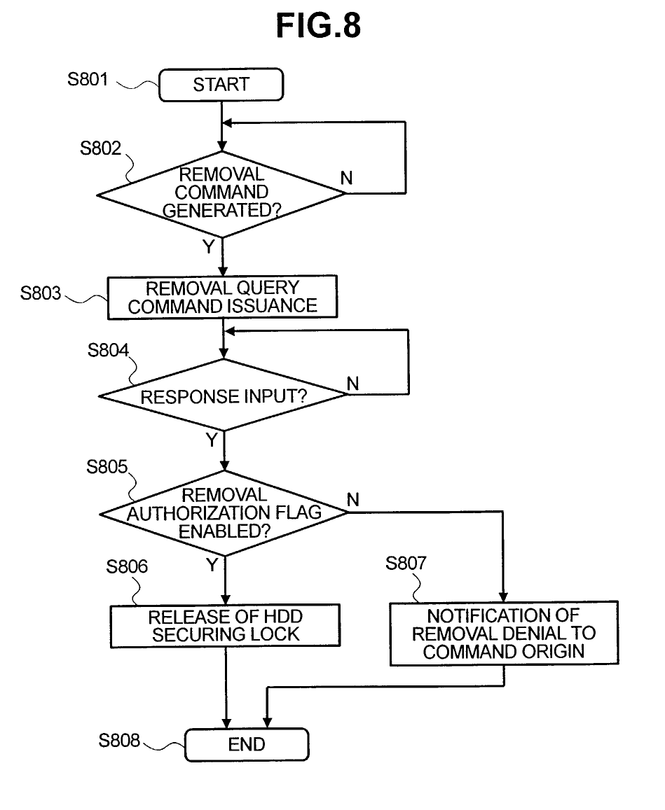

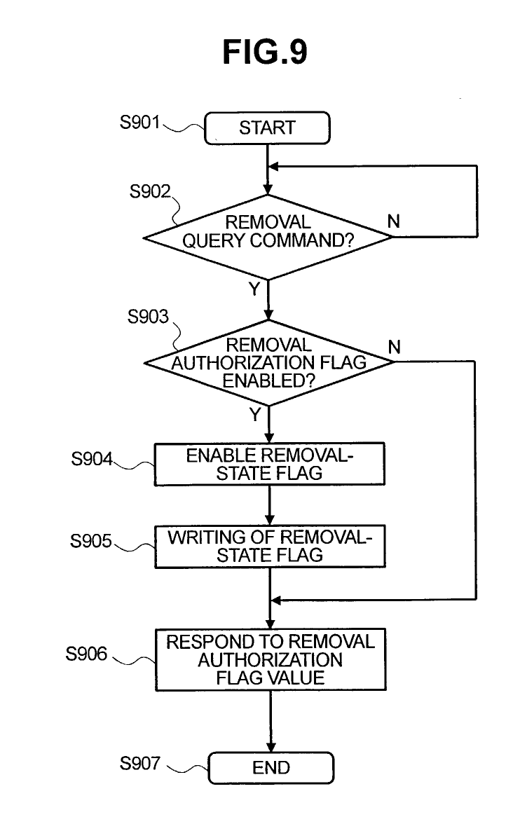

FIGS. 8 and 9 depict the process necessary for removing the hard disk device 101 from the set-top box 102. FIGS. 8 and 9 are flowcharts of each process in the host unit 201 and the hard disk device 101, respectively. The host CPU 210 issues removal process instructions to the HDD interface controller 202 when a removal command for the hard disk device 101 is generated in accordance with the instructions of a user or the like (S802). When instructions are received, the removal control unit 213 issues a query command to the hard disk device 101 to determine whether the hard disk device 101 may be removed (S803). If the response from the hard disk device 101 gives permission for removal, the removal control unit 213 directs the locking mechanism 212 to release the lock securing the hard disk device 101 (S806). If the response denies permission for removal, the user or other removal command source is informed to that effect (S807).

The hard disk device 101 returns the removal authorization flag register 224 value to the host unit 201 (S906) when a removal query command is received (S902). The hard disk device 101 sets the removal-state flag register 225 value to an enabled state (S904) when the removal authorization flag register 224 value indicates an enabled state, and stores this value in the recording medium (S905). Causes for the generation of a command to remove the hard disk device 101 include not only requests from the user, but also commands based on failure or forecast of failure.

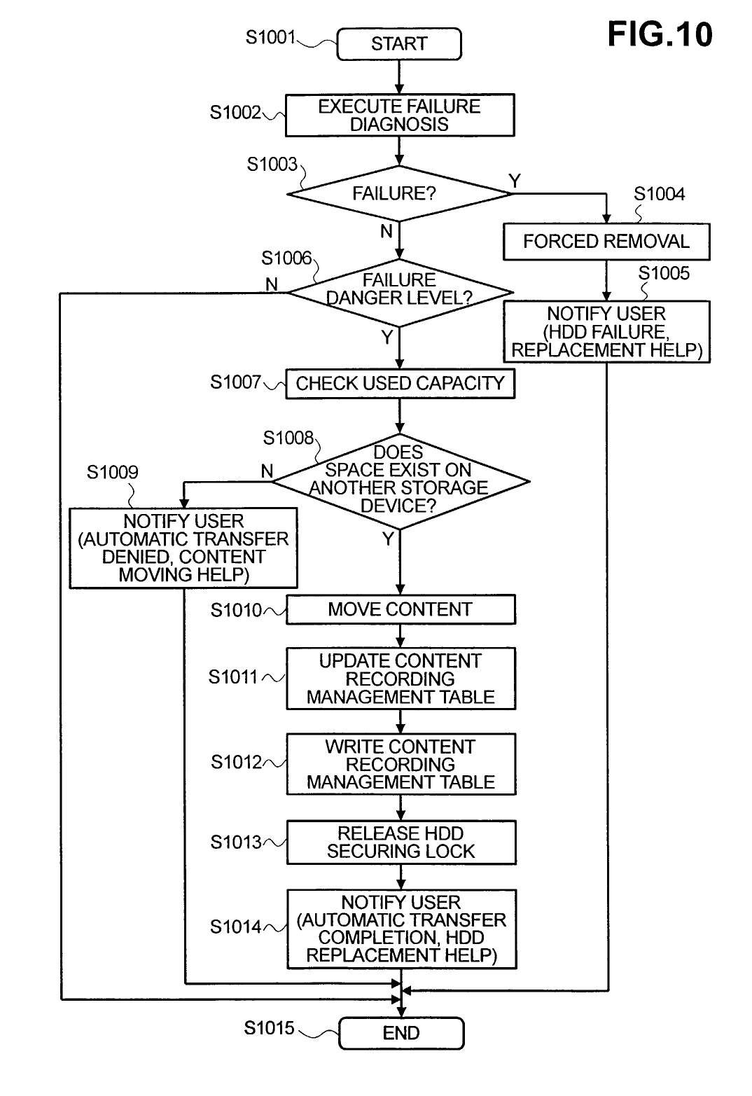

FIG. 10 is a flowchart of a failure-diagnosing routine for the hard disk device 101 in the host unit 201. The hard disk device 101 usually possesses failure-forecasting/diagnostic functionality known as SMART (Self-Monitoring, Analysis, and Reporting Technology). This is a technique for forecasting hard disk device 101 failures in advance by examining the number of retry occurrences generated during read routines, the number of generated errors that cannot be corrected by ECC, the number of occurrences of replacement processing, and the like. Failure forecasting diagnosis for the hard disk device 101 is executed at regular intervals according to host unit 201 instructions or disk CPU 216 instructions (S1002).

When the hard disk device 101 cannot be accessed (the hard disk device 101 has failed), the removal control unit 213 instructs the locking mechanism 212 to force the release of the lock (S1004). The removal control unit 213 notifies the user of hard disk device failure and advises the replacement of the hard disk device 101 (S1005). In this case, even if an unauthorized person were able to create the appearance of failure and remove the hard disk device 101, the use thereof in another host unit 201 (as depicted in FIG. 4) is impossible, and copyrights can thus be protected because the value of the removal-state flag register 225 will correspond to a disabled state in this case.

If the hard disk device 101 has not failed, the removal control unit 213 determines whether the hard disk device 101 has reached a failure danger level (S1006). The failure danger level is set by presetting a level at which the failure probability becomes high when a certain value is reached according to diagnostic results obtained by means of SMART.

The hard disk device 201 must be replaced when the hard disk device 101 reaches the danger level. The host unit 201 checks the capacity used in the hard disk device 101 to be replaced (S1007). The host unit 201 checks for the existence of unused areas of larger capacity in other accessible storage devices (S1008). If space exists on another storage device, the host unit 201 moves all content-containing data to the open areas (S1010), updates the entries in the content recording management tables 222 of the origin and destination hard disk devices 101 (S1011), and stores the table information in the recording medium (S1012). Because the hard disk device 101 to be removed becomes removable in this step, the locking mechanism 212 releases the HDD securing lock (S1013) and notifies the user of the completion of content transfer and supplies help concerning hard disk device replacement (S1014). The user is advised to move content when no open areas exist (S1009).

The host CPU 210 is notified of an upgrade via the user interface controller 209 when the user desires to upgrade the hard disk device 101. The host CPU 210 issues a removal query command to the hard disk device 101. If the response from the hard disk device 101 indicates the capability of removal, the locking mechanism 212 releases the HDD lock. If the response denies possibility of removal, the host CPU 210 reads the content recording management table 222 and examines for removal-disabling content. The host CPU 210 moves the content to another storage device according to the procedure under S1008 in FIG. 10. The locking mechanism 212 releases the HDD lock.

The copy control information 307 and the removal control information 308 are assumed to be set by the content transmitting party in the present embodiment, but may also be set by the user. The host unit 201 in this case preferably generates the header information 601 in place of the user and sends packets to the hard disk device 101 according to the user's wishes.

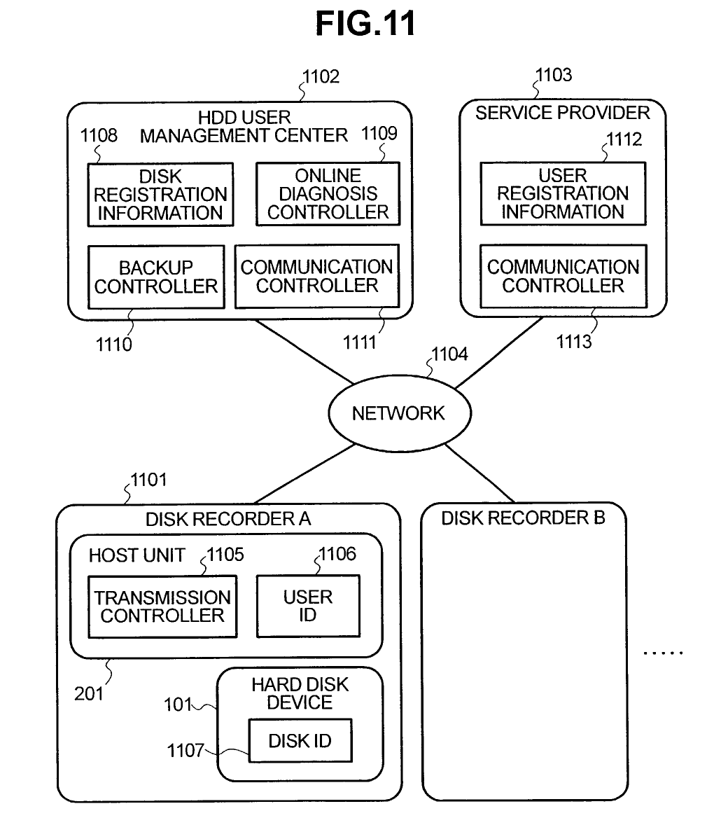

FIG. 11 is a block diagram of an online maintenance service system for a disk recorder 1101, and is the second embodiment Of the present invention. The disk recorder 1101, a service provider 1103, and a HDD user management center 1102, are connected by a network 1104.

The disk recorder 1101 comprises a recording device that houses the hard disk device 101. The structure of the disk recorder 1101 is identical to that of the set-top box 102; however, the host unit 201 differs from the first embodiment in that bidirectional data transfer with the external network 1104 is possible by means of a transmission controller 1105. The host unit 201 carries a user ID issued by the service provider 1103. The hard disk device 101 carries a disk ID inherent to the hard disk device 101. The disk ID may be determined by the maker prior to shipment of the hard disk device 101, or may be issued by the HDD user management center 1102 after shipment. The service provider 1103 comprises a communication controller 1113 for transmitting content as desired by the user, and registration information 1112 for each user participating in the service. The HDD user management center 1102 communicates with the disk recorder 1101 and the service provider 1103 via the communication controller 1111. The HDD user management center 1102 performs failure diagnosis and upgrades in the online diagnosis controller 1109 for the hard disk device 101 used by the users affiliated with the service provider 1103. In so doing, a backup controller 1110 performs data backup for the hard disk device 101 as necessary. The HDD user management center 1102 ascertains the status of each hard disk device 101 using disk registration information 1108. The network 1104 may utilize a dedicated line or the Internet.

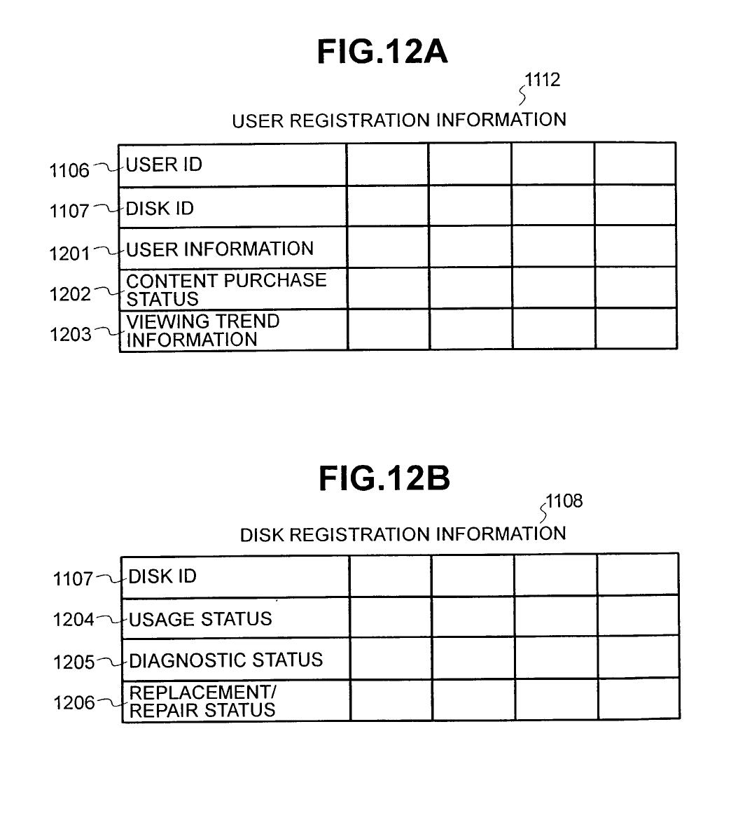

FIG. 12 depicts an example of the user registration information 1112 and the disk registration information 1108. The disk ID 1107, user information 1201, content purchase status 1202, and viewing trend information 1203 for each user ID issued by the provider 1103 are managed in the user registration information 1112 in FIG. 12A. The disk ID 1107 stores information indicating the disk ID 1107 of the hard disk device 101 in which the transmitted content is stored. The user's name, address, membership expiration date, and similar personal information are stored in the user information 1201. The personal information is acquired when the user registers for membership. Information showing a list of content purchased by the user is stored in the content purchase status 1202. The results of user preference analysis from the content recorded in the hard disk device 101 are stored in the viewing trend information 1203.

Usage status 1204, diagnostic status 1205, and replacement/repair status 1206 for each disk ID are managed in the disk registration information 1108 in FIG. 12B. Information showing the frequency and habits with which the user accesses the hard disk device 101 are stored in the usage status 1204. Using these data, the hard disk device maker can thus ascertain definite user needs such as desired device durability, and can obtain feedback for future products. Hard disk device 101 failure-forecasting diagnostic results are stored in the diagnostic status 1205. The failure-forecasting diagnosis may use the SMART functionality described in the first embodiment, or a diagnostic method that is specific to the hard disk device maker. Diagnosis may also be instructed to be performed internally by the hard disk device 101 itself, or by the disk recorder 1101 or HDD user management center 1102. Information showing a failure of the hard disk device 101, an upgrade replacement, or repair status is stored in the replacement/repair status 1206.

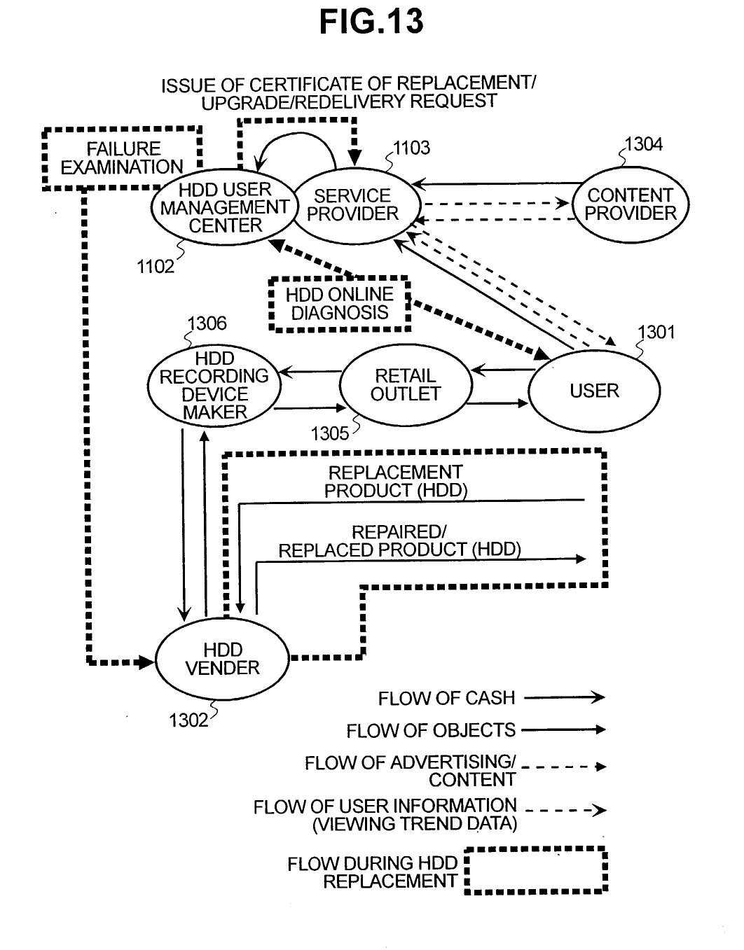

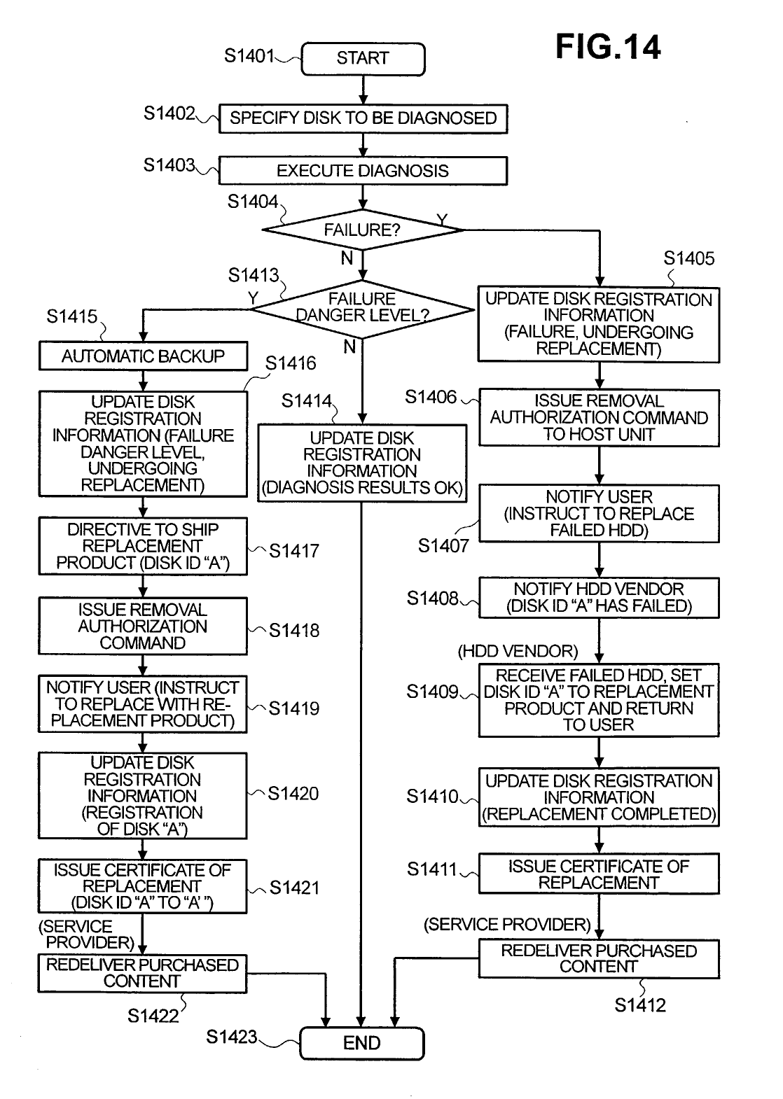

FIG. 13 is an example of a business model that uses the online maintenance service system depicted in FIG. 11. A user 1301 purchases a disk recorder 1101 containing a hard disk device 101 from a retail outlet 1305. The user 1301 enters into a contract with the service provider 1103 and receives service using the disk recorder 1101. A content provider 1304 provides content to the user 1301 through the service provider 1103. The HDD user management center 1102 performs online maintenance for the hard disk device 101 used by the user 1301, and charges a maintenance fee to the user 1301 through the service provider 1103.

The online maintenance service provided by the HDD user management center 1102 provides failure diagnosis for the hard disk device 101 and replacement support for upgrades and the like. Before implementing the service, the HDD user management center 1102 obtains the disk registration information 1108 for the hard disk device 101 that is to be maintained. More specifically, the service provider 1103 should communicate with the HDD user management center 1102 when the service provider 1103 performs user registration, because the disk ID 1107 of the hard disk device 101 being used can be obtained at the same time. When the network 1104 is associated with the Internet, the hard disk device 101 can be accessed directly from the HDD user management center 1102 if an IP address is allocated in advance to the disk recorder 1101, host unit 201, and hard disk device 101.

FIG. 14 is a flowchart of an online maintenance service routine based on the HDD user management center 1102. The HDD user management center 1102 designates the hard disk device 101 to be diagnosed (S1402), and diagnoses the disk device 101 (S1403). For the diagnosis, a diagnosis command may be issued directly from the HDD user management center 1102, or internal self-diagnosis may be executed in the disk device 101 and the results thereof reported to the management center 1102. In cases where diagnostic results indicate that the disk device 101 (disk ID “A,” for example) is inaccessible or the like, or has failed, the HDD user management center 1102 updates the disk registration information 1108 (diagnostic status 1205 and replacement/repair status 1206). Specifically, the fact is recorded that the diagnostic results indicate failure, and that the failed disk device is undergoing replacement (S1405).

The HDD user management center 1102 issues removal and authorization commands to the host unit 201 to remove the failed hard disk device 101 from the disk recorder 1101 (S1406). The host unit 201, as a rule, does not perform removal if the hard disk device 101 removal authorization flag register 224 value does not indicated an enabled state, but the HDD securing lock is also released by means of a command from the HDD user management center 1102. The host unit 201 sends a message to the user 1301 indicating that because failure has occurred, the removed hard disk device 101 should be returned to the HDD vendor 1302 (S1407).

The HDD user management center 1102 notifies the HDD vendor 1302 of the fact that the hard disk device 101 having the disk ID 1107 “A” has failed (S1408). After the HDD vendor 1302 receives the failed hard disk device 101 from the user 1301, the disk ID 1107 of the replacement product is registered to “A” and sent to the user 1301 in return (S1409). The HDD user management center 1102 performs an update of the disk registration information 1108 (replacement/repair status 1206) for the disk ID “A” (S1410) when the user 1301 sets the replacement product into the disk recorder 1101. The HDD user management center 1102 issues a certificate of failure to the service provider 1103 for the disk ID 1107 “A” (S1411). The certificate of failure is designed to certify that the hard disk device 101 has failed and was exchanged for a replacement product according to the proper procedure. Upon receipt of the certificate, the service provider 1103 uses the user registration information 1112 to examine the content already purchased by the user 1301 on the basis of the content purchase status 1202 registered to the disk ID 1107 “A,” and reassigns the results to the replacement product (S1412).

When the diagnostic results indicate that no failure has occurred, but that the failure danger level has been reached, the backup controller 1110 performs automatic backup of the disk device 101 data (S1415). The automatic backup service may be designed such that the user chooses at the time of registration whether or not to receive the service. The backup destination may consist of a storage device maintained by the management center 1102, or another storage device used by the user 1301. The area usable by the user of the hard disk device 101 may be limited to a certain extent, and a portion of a hard disk device 101 installed in the disk recorder 1101 of another user 1301 affiliated with the service provider 1103 may be used.

Backup is distributed among a plurality of users when there is insufficient recording capacity for a single user 1301. A user 1301 may also receive a discount to the cost of service when receiving back service (*1). The user 1301 may designate a directory for backup in advance, such that only the directory is backed up. After backup is completed, the HDD user management center 1102 performs an update of the disk registration information 1108 (diagnostic status 1205 and replacement/repair status 1206) (failure danger level attained, S1416). The HDD user management center 1102 directs the HDD vendor 1302 to ship the replacement product (disk ID “A′”) having the disk ID “A” (S1417). The HDD user management center 1102 issues a removal authorization command to the host unit 201 (S1418) in the same manner as when failure occurs. In this case, a command may be directly issued to enable the removal and authorization flag register 224 value for the hard disk device 101, because the hard disk device 101 has not yet failed (S1418).

The host unit 201 instructs the user 1301 to replace the hard disk device 101 (S1419). When the user 1301 replaces the hard disk device 101, the HDD user management center 1102 registers the disk ID “A′” to the disk ID 1107 (S1420) and issues a certificate of replacement to the service provider 1103 (S1421). The certificate of replacement is designed to certify that the disk device 101 has been changed from disk ID “A” to disk ID “A′”. Upon receipt of the certificate, the service provider 1103 changes the information registered in the disk ID 1107 from “A” to “A′” by using the user registration information 1112 and examines the content already purchased by the user 1301 on the basis of the content purchase status 1202 registered to “A,” and reassigns the results to the replacement product (S1422).

The user 1301 sends a request to the service provider 1103 when desiring to upgrade the hard disk device 101 being used by the user 1301 (or when desiring to use an old hard disk device 101 for a different application). The service provider 1103 examines the hard disk device 101 for purchased (paid) content using the user registration information 1112. When purchased content exists, the service provider 1103 moves the content to another storage device, or issues a request to the HDD user management center 1102 for deletion. The HDD user management center 1102 communicates with the hard disk device 101, examines for unremovable content, arid issues a command to execute movement or deletion.

The present embodiment focuses on a hard disk device 101; however, it is apparent that application can also be made to read/write-capable storage devices such as optical-magnetic disk devices and semiconductor memory devices. Furthermore, the loading and unloading of a recording medium such as a DVD disk or cassette tape can be controlled in like manner by storing a content recording management table 222, host ID register 223, removal authorization flag register 224, and removal-state flag register 225 such as those as depicted in FIG. 2, or a disk ID 1107 such as the one depicted in FIG. 11, in the recording medium itself.

The removal of a disk device in which content is recorded can be locked as needed, and copyrights can be protected in an information processing device that houses a removable hard disk device, as described above with reference to the present invention.

Copyrights can also be protected by disabling access to content by information processing devices other than that which recorded the content.

The portability and convenience of disk devices can also be enhanced by allowing free removal when the recorded content consists solely of material that does not require copyright protection.

A failed disk device can also be easily removed, and user inconvenience associated with the failure can be kept to a minimum while protecting copyrights, because content that requires copyright protection is also moved to another storage device when situations of imminent failure are detected. Because only the disk device requires repairs or replacement in this case, the cost and time required for repairs and replacement can be minimized.

User inconvenience associated with such failures can also be kept to a minimum for authorized users while preventing improper distribution of content to unauthorized users in a service system that performs disk device maintenance online when a disk device that has recorded purchased content fails, or is replaced due to the detection of an imminent failure situation, because failure or replacement is authenticated at a maintenance center, and the service provider redistributes purchased content to the hard disk device after replacement.

### INDUSTRIAL APPLICABILITY

As described above, the information processing device according to the present invention is useful for distributing and recording content while protecting the copyright thereof, and is particularly suitable for recording content on a portable HDD recorder.

1. An information processing device comprising a removable recording/playback device incorporated therein, further comprising:
locking means for disabling the removal of the recording/playback device;
command-issuing means for issuing a command for authorizing removal of the recording/playback device; and
judgment means for judging whether the removal is authorized or disabled on the basis of the command response,
wherein when the judgement means authorizes the removal, the removal of the recording/playback device is enabled by instructing the locking means to release the lock.

2. The information processing device according to claim 1, wherein when content that disables removal of the recording/playback device is recorded, the judgment means responds to the command to disable the release of the lock.

3. The information processing device according to claims 1 and 2, wherein content identification information comprises flag information indicating whether or not removal of the recording/playback device is authorized when the content is recorded.

4. An information processing device comprising a removable recording/playback device incorporated therein, the information processing device further comprising:
command-issuing means for notifying the recording/playback device of a host ID that is specific to the information processing device,
wherein the recording/playback device comprises means for retaining a issued host ID, and a content recording management table for managing a content ID specific to the content for each piece of recorded content, a host ID for the information processing device that has instructed a write routine for the content, and content effective flag information for indicating whether the currently connected information processing device is able to access the content, so that the recording/playback device compares the host ID issued after system reset and the host ID in the management table, sets the content effective flag to an enabled state for consistent entries, and thereby authorizes an access from the information processing device.

5. The information processing device according to claim 4, wherein the content recording management table further comprises flag information for indicating whether or not the removal of the recording/playback device is authorized when the content has been recorded,
wherein the recording/playback device is disabled to remove when the flag information disables removal of the recording/playback device for at least one entry on the content recording management unit.

6. The information processing device according to claims 4 and 5, wherein the recording/playback device retains removal-state flag information,
wherein the removal-state flag is set before the removal is carried out,
wherein when the recording/playback device is reinstalled, the retained host ID is compared with the host ID issued after installation;
wherein access to content whose content effective flag has been set to an enabled state is authorized when consistency is confirmed, while the removal-state flag is further examined when inconsistency is confirmed;
wherein if the removal-state flag indicates an enabled state, new host ID is retained while, at the same time, entries that are consistent with the new host ID are searched for in the content recording management table, and the content effective flag is set to an enabled state; and
wherein if the removal flag indicates a disabled state, access from the information processing device is disabled.

7. The information processing device according to claim 1, further comprising means for executing failure-forecasting/diagnosis of the recording/playback device,
wherein if it is judged as a diagnostic result, that the recording/playback device has failed, the recording/playback device is forcibly authorized to remove.

8. A maintenance service system, obtained by mutually coupling an information processing device comprising a removable recording/playback device incorporated therein, a management center for the recording/playback device, and a service provider for providing content,
wherein the recording/playback device has a device ID specific to the recording/playback device;
wherein the management center authorizes removal of the recording/playback device when it is judged that replacement is required, as the result of failure diagnostic for the recording/playback device, and certify that the replacement has been performed properly by managing the correspondence between the device ID of the newly installed recording/playback device following removal and the device ID prior to removal; and
wherein the service provider redelivers the content retained by the recording/playback device prior to removal to the recording/playback device following removal, on the basis of the certification.

9. The maintenance service system according to claim 8, wherein the management center authorizes removal of the recording/playback device when it is judged that replacement is required due to risk of failure, as the result of failure diagnostic for the recording/playback device, and certifies that the replacement has been performed properly by managing the correspondence between the device ID of the recording/playback device following removal and the device ID prior to removal; and
the service provider redelivers the content retained by the recording/playback device prior to removal to the recording/playback device after removal, on the basis of the certification.

10. The maintenance service system according to claims 8 and 9, wherein when a user desires an upgrade of the recording/playback device, the management center moves the content that disables removal to attain a sate in which removal is authorized, thereafter authorizes the removal, and certifies that the upgrade has been performed properly by managing the correspondence between the device ID of the new recording/playback device and the old device ID; and
wherein the service provider redelivers the content retained by the old recording/playback device to the new recording/playback device, on the basis of the certification.
